(19) United States
(12) Patent Application Publication
(10) Pub. No.: US 2024/0342815 A1
(43) Pub. Date: Oct. 17, 2024

(54) THREAD MACHINING APPARATUS, METHOD AND SYSTEM

(71) Applicant: ABB SCHWEIZ AG, Baden (CH)

(72) Inventors: Jiageng Liu, Shenyang (CN); Yong Chen, Shanghai (CN); Yin Tian, Shanghai (CN); Yang Chen, Shanghai (CN)

(21) Appl. No.: 18/751,475

(22) Filed: Jun. 24, 2024

Related U.S. Application Data
(63) Continuation of application No. PCT/CN2022/103991, filed on Jul. 5, 2022.

(51) Int. Cl. B23G 1/18; B23G 1/48

(52) U.S. Cl. CPC B23G 1/18; B23G 1/48

(57) ABSTRACT

Embodiments of present disclosure relate to thread machining apparatus (300), method and system. The thread machining apparatus (300) comprises: a spindle motor (310) adapted to drive a thread tool (200) coupled to an output shaft of the spindle motor (310) to rotate at a rotational speed; and a feeding device (320) movably coupled to the spindle motor (310), and configured to drive the spindle motor (310) to move along an axial direction (X) of the spindle motor (310) at a moving speed; wherein during thread machining, the moving speed is proportional to the rotational speed. The solutions of the embodiments of present disclosure have significantly improved the efficiency, stability and accuracy of thread machining.

### FIELD

Embodiments of the present disclosure generally relate to the field of thread machining, and more particularly, to a thread machining apparatus, method and system.

### BACKGROUND

Threads are widely used in mechanical connection. The machining accuracy of threads has an important impact on the quality of the threads. There are many thread machining methods, such as thread rolling based on plastic deformation, turning, milling, tapping, threading, grinding, cyclone cutting based on cutting, which are usually machined on lathes and milling machines. Among them, tapping is a main way to machine the internal threads. Tapping is to screw the tap into the predrilled bottom hole on the workpiece with a certain torque to machine the internal thread on the inner cylindrical surface of the workpiece.

Traditional method for thread machining includes manual tapping, machining threads on CNC (Computerized Numerical Control) lathe, etc. The manual tapping has the defect of low efficiency and low machining accuracy, while machining threads on CNC has the defect of high cost and large floor space.

There thus is a need for an improved thread machining apparatus and thread machining method.

### SUMMARY

In view of the foregoing problems, various example embodiments of the present disclosure provide a thread machining apparatus, method and system to overcome at least one of the above mentioned defects or potential other defects.

In a first aspect of the present disclosure, example embodiments of the present disclosure provide a thread machining apparatus. The thread machining apparatus comprises: a spindle motor adapted to drive a thread tool coupled to an output shaft of the spindle motor to rotate at a rotational speed; and a feeding device movably coupled to the spindle motor, and configured to drive the spindle motor to move along an axial direction of the spindle motor at a moving speed; wherein during thread machining, the moving speed is proportional to the rotational speed.

With such an arrangement, the synchronization of feed and tapping can be achieved, thereby improving machining accuracy of the thread.

In some embodiments, a ratio of the moving speed to the rotational speed is equal to the pitch of the thread tool. In this way, since the ratio of the moving speed to the rotational speed can be adjusted according to the pitch to be machined, the machining accuracy of the threads can be improved significantly.

In some embodiments, the feeding device comprises: a servo motor; and a transmission device coupled with an output shaft of the servo motor and configured to convert the rotation of the output shaft of the servo motor into a linear movement along the axial direction of the spindle motor to drive the spindle motor.

With such an arrangement, the transmission device converts the rotation of the output shaft of the servo motor into a linear movement along the axial direction of the spindle motor to drive the spindle motor, thus enabling the spindle motor to achieve an accurate linear movement.

In some embodiments, the transmission device comprises: a gear box coupled to the output shaft of servo motor; a ball screw movably coupled with a gear in the gear box; a ball nut arranged on the ball screw, and configured to move along an axial direction of the ball screw with the rotation of the ball screw; and a sliding member coupled between the ball nut and the spindle motor, the sliding member sliding with the movement of the ball nut to drive the spindle motor to move along the axial direction of the spindle motor.

With such an arrangement, the rotation of the output shaft of the servo motor can be converted into a linear movement along the axial direction of the spindle motor in a simple and reliable way.

In some embodiments, the transmission device comprises: a first belt pulley fixedly coupled to the output shaft of the servo motor; a gear box; a second belt pulley fixedly coupled to a shaft of the gear box; a belt coupled the first belt pulley with the second belt pulley to drive the second belt pulley along with the first belt pulley; and a sliding member coupled between the gear box and the spindle motor, the sliding member sliding with the rotation of the output shaft of the servo motor to drive the spindle motor to move along the axial direction of the spindle motor.

With such an arrangement, the rotation of the output shaft of the servo motor can be converted into a linear movement along the axial direction of the spindle motor in a simple and reliable way.

In some embodiments, the transmission device comprises: a first belt pulley fixedly coupled to the output shaft of the servo motor; a belt; a second belt pulley coupled to the first belt pulley via the belt; a ball screw coupled to a shaft of the second belt pulley and rotates with the rotation of the second belt pulley; a ball nut arranged on the ball screw, and configured to move along the axial direction of the ball screw with the rotation of the ball screw, and a sliding member coupled between the ball nut and the spindle motor, the sliding member sliding with the movement of the ball nut to drive the spindle motor to move along the axial direction of the spindle motor.

In some embodiments, the moving speed is proportional to product of a circumference of the first belt pulley and a rotational speed of the servo motor.

With such an arrangement, the moving speed of the spindle motor can be accurately controlled in a simple way.

In some embodiments, the transmission device further comprises: a sliding track extending along the axial direction of the spindle motor, wherein the sliding member sliding along the sliding track.

With such an arrangement, the spindle motor can be driven along the sliding track smoothly.

In some embodiments, the apparatus further comprises: a positioning mechanism fixedly coupled with the feeding device and suitable for positioning the position of the feeding device to align the thread tool with a hole of a thread to be machined of the workpiece.

With such an arrangement, since the positioning mechanism can move freely in a predetermined space, the output shaft of the spindle motor can be conveniently moved to the part to be machined.

In some embodiments, the positioning mechanism comprises a robot, and the feeding device is fixedly coupled to an end of a mechanical arm of the robot.

With such an arrangement, the machining efficiency can be significantly increased by taking advantage of robots.

In some embodiments, the spindle motor comprises: a clamping part adapted to hold the thread tool; a controller adapted to control the rotational speed of the spindle motor; and an encoder coupled to the controller and configured to transmit the rotation number of the spindle motor to the controller of the spindle motor in a speed control mode, so that the controller controls the rotational speed of the spindle motor; and transmit the position of the clamping part of the spindle motor holding the thread tool in a position control mode, so as to control the output shaft of the spindle motor to rotate to a predetermined position to replace the thread tool.

The speed control mode and position control mode are switched by a controller according to machining program. By default, the speed control mode is used. When it enters a tool change program and the clamping part reaches the tool change point, it switches to the position control mode, and rotates the shaft of the spindle motor to a zero point to take and replace the thread tool. In brief, the position control mode is only used in the tool change program (stage), and the speed control mode is used by default for others.

With such an arrangement, the rotational speed of the spindle motor accurately and the replacement of the thread tool can be controlled conveniently.

In some embodiments, the thread tool comprises a tap. With such an arrangement, the thread can be machined in a cost efficient and reliable way.

In a second aspect of the present disclosure, example embodiments of the present disclosure provide a thread machining method, comprising: driving a thread tool coupled to an output shaft of a spindle motor to rotate at a rotational speed; and driving the spindle motor to move along a axial direction of the spindle motor at a moving speed; wherein during thread machining, the moving speed is proportional to the rotational speed.

With such an arrangement, it enables the synchronization of feed and tapping, thereby improving machining accuracy of the thread.

In some embodiments, a ratio of the moving speed to the rotational speed is equal to the pitch of the thread tool.

With such an arrangement, the synchronization of feed and tapping can be achieved, thereby improving the machining accuracy of the thread.

In some embodiments, the spindle motor and the feeding device are controlled synchronously, so that the ratio of the moving speed to the rotational speed is equal to the pitch of the thread tool during tapping and exiting from a threaded hole.

With such an arrangement, it ensures the synchronization of feed and tapping, so as to obtain a good thread shape.

In some embodiments, the spindle motor and the feeding device are controlled synchronously, so that the ratio of the moving speed to the rotational speed is equal to the pitch of the thread tool at least from the time when the thread tool reaches the hole on a workpiece surface where the thread is to be machined.

With such an arrangement, it ensures the synchronization of feed and tapping, thereby improving the machining accuracy of the thread to obtain a good thread shape.

In some embodiments, the spindle motor and the feeding device are synchronously controlled by a same controller.

With such an arrangement, the synchronous control of spindle motor and the feeding device can be conveniently and reliably realized.

In a third aspect of the present disclosure, example embodiments of the present disclosure provide a system comprising the thread machining apparatus mentioned above.

It is to be understood that the summary section is not intended to identify key or essential features of embodiments of the present disclosure, nor is it intended to be used to limit the scope of the present disclosure. Other features of the present disclosure will become easily comprehensible through the following description.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 is a schematic sectional view of an internal thread;

FIG. 2 is a front view of a tap;

FIG. 3 is a perspective view of a thread machining apparatus in accordance with an embodiment of the present disclosure;

FIG. 4 is a front view of the thread machining apparatus as shown in FIG. 3;

FIG. 5 is a perspective view of a robot in the thread machining apparatus as shown in FIG. 3;

FIG. 6 is a top view of a spindle motor and a feeding device of the thread machining apparatus as shown in FIG. 3;

FIG. 7 is a perspective view of the spindle motor as shown in FIG. 6;

FIG. 8 is a top view of a feeding device in accordance with an embodiment of the present disclosure;

FIG. 9 is a front view of the feeding device as shown in FIG. 8;

FIG. 10 is schematic top view illustrating the configuration of the feeding device in accordance with an embodiment of the present disclosure;

FIG. 11 is schematic bottom view of the feeding device as shown in FIG. 10;

FIG. 12 is schematic top view illustrating the configuration of the feeding device in accordance with another embodiment of the present disclosure;

FIG. 13 is schematic top view illustrating the configuration of the feeding device in accordance with still another embodiment of the present disclosure; and

FIG. 14 is a schematic block diagram illustrating the system comprising the thread machining apparatus in accordance with an embodiment of the present disclosure; and

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

As mentioned in the background, the traditional method for thread machining has the defects of low efficiency, high cost, and low machining accuracy.

Generally speaking, there are three methods for thread machining:

### 1. Machining Threads on CNC (Computerized Numerical Control) Lathe.

CNC lathe covers a large area, which is not conducive to cooperate with other equipment to realize automatic production line. The cost of CNC lathe itself is very high. Moreover, customized tooling fixtures are needed to adapt to machining of different workpieces, and thus the flexibility is poor. In addition, it needs complex programming and high skills of operators.

### 2. Manual Tapping.

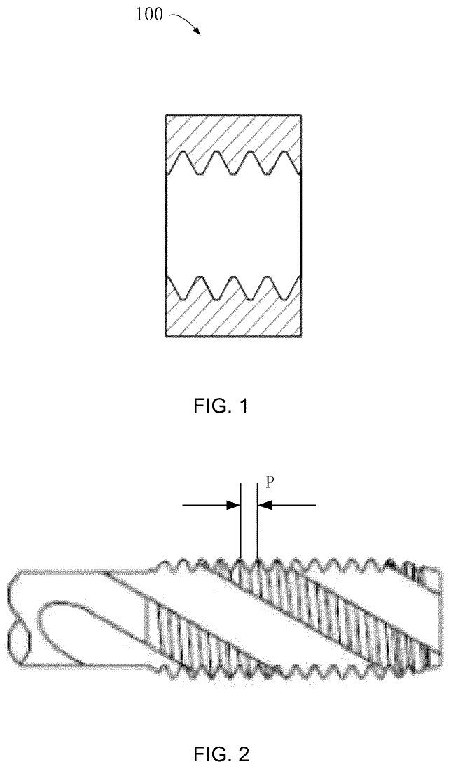

As mentioned above, tapping is to screw the tap into the predrilled bottom hole on the workpiece with a certain torque to machine the internal thread on the inner cylindrical surface of the workpiece. FIG. 1 illustrates a schematic sectional view of an internal thread, and FIG. 2 is a front view of a tap, which can be utilized when manually tapping the internal thread in FIG. 1. This manual tapping has the defects of high labor cost, low efficiency and low reliability.

### 3. Using a 6-Axis Industrial Robot.

The 6-axis industrial robot is used to directly load the spindle motor and screw tap with its flange for thread machining. However, the 6-axis industrial robot has the problem of insufficient rigidity. If it is directly connected with the motorized spindle and the high-speed thread drilling cutter head in the mechanical structure, it is very likely that the external force generated by the cutter head during high-speed rotation has a dynamic impact on the transmission mechanism of the robot body, resulting in negative reaction force and motion deviation which affect the machining accuracy. In addition, thread machining not only has problems such as high cost, low efficiency and poor stability, but also has strict requirements for the synchronization between the motorized spindle and the tap, as well as other motion mechanism of thread machining, otherwise it will produce motion block and directly affect the quality of thread.

In the process of thread machining, cutting edge is long, and it is easy to have broken edge and gnawing of the machined surface of workpiece by the cutter. In order to ensure the accuracy, there must be an appropriate cut in and cut out length. The feed rate and rotational speed of the spindle during thread machining must maintain a strict transmission ratio to avoid serious problems such as thread sliding (screw loose), damage to surface roughness, tool material plasticity damage and so on.

In view of the forgoing, according to embodiments of the present disclosure, a new thread machining apparatus, method and system are provided in the present invention. The thread machining apparatus comprises a spindle motor and a feeding device. The spindle motor has an output shaft. The thread tool can be coupled to the output shaft of the spindle motor. The spindle motor can drive the thread tool to rotate at a rotational speed. The feeding device can be movably coupled to the spindle motor, and drive the spindle motor to move along an axial direction of the spindle motor at a moving speed. During thread machining, the moving speed can be proportional to the rotational speed. The above idea may be implemented in various manners, as will be described in detail in the following paragraphs.

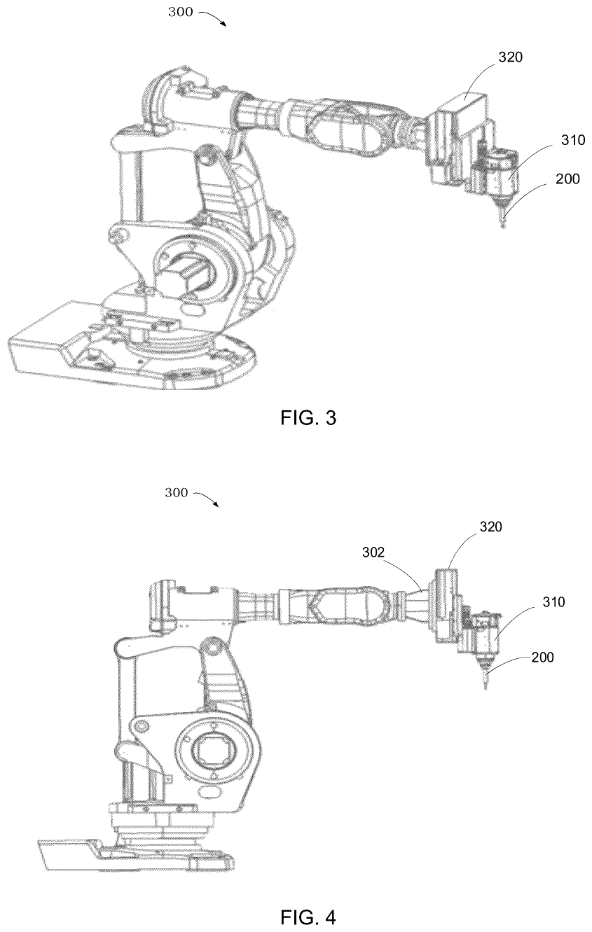

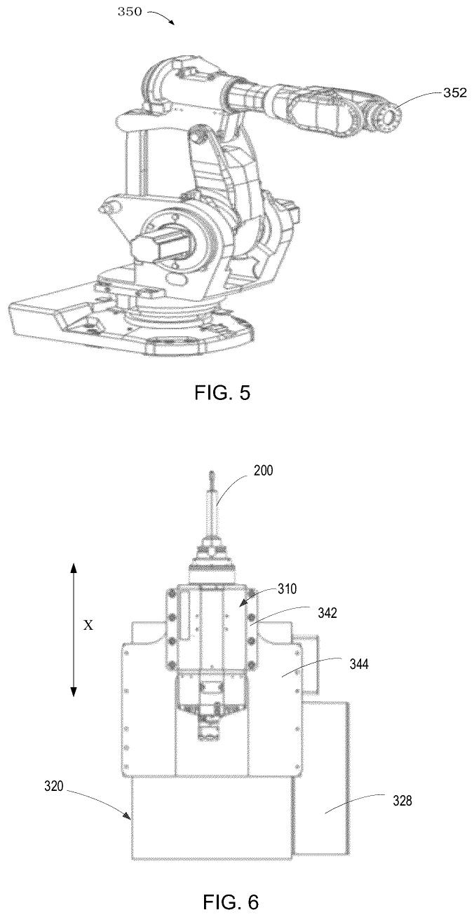

Hereinafter, the principles of the present disclosure will be described in detail with reference to FIGS. 3-14. Referring to FIGS. 3-5 first, FIG. 3 is a perspective view of a thread machining apparatus in accordance with an embodiment of the present disclosure, FIG. 4 is a front view of the thread machining apparatus as shown in FIG. 3 and FIG. 5 is a perspective view of the robot as shown in FIG. 3.

In some embodiments, as shown in FIGS. 3 and 4, the thread machining apparatus 300 includes a spindle motor 310 and feeding device 320. The spindle motor 310 is adapted to drive a thread tool 200, which is coupled to an output shaft of the spindle motor 310, to rotate at a rotational speed. For example, the thread tool 200 may be the tap as shown in FIG. 2. The feeding device 320 is movably coupled to the spindle motor 310, and configured to drive the spindle motor 310 to move along an axial direction X of the spindle motor 310 at a moving speed. Wherein during thread machining, the moving speed is proportional to the rotational speed. In some embodiments, a ratio of the moving speed to the rotational speed is equal to the pitch of the thread tool 200. In this way, the synchronization of feed and tapping can be achieved, thereby improving the machining accuracy of the thread.

In some embodiments, as shown in FIG. 5, the thread machining apparatus 300 may further include a positioning mechanism 350, which is fixedly coupled with the feeding device 320 and adapted to locate the position of the feeding device 320, so that the thread tool 200 aligns with the hole of the thread to be machined of the workpiece.

As shown in FIGS. 3-5, the positioning mechanism 350 forms main body of thread machining apparatus 300. Specifically, the positioning mechanism 350 may be a robot. The robot may be a 6-axis industrial robot. The 6-axis industrial robot is connected with the feeding device 320 at the robot flange 352 to form 7 spatial degrees of freedom. The 6-axis industrial robot may be set near the workpiece to be machined. When thread holes are machined, the 6-axis industrial robot remains stationary. The spindle motor 310 is coupled to the feeding device 320 which makes the thread tool 200 together with spindle motor 310 move in a linear direction. The positioning mechanism 350 can move the feeding device 320 to any position within a predetermined range from the positioning mechanism 350. In particular, the positioning mechanism 350 can move the feeding device 320 to a predetermined position such that the output shaft of the spindle motor 310 to be aligned with the hole of a workpiece to be machined. In this way, it enables to conveniently position the output shaft of the spindle motor 310 to the workpiece to be machined.

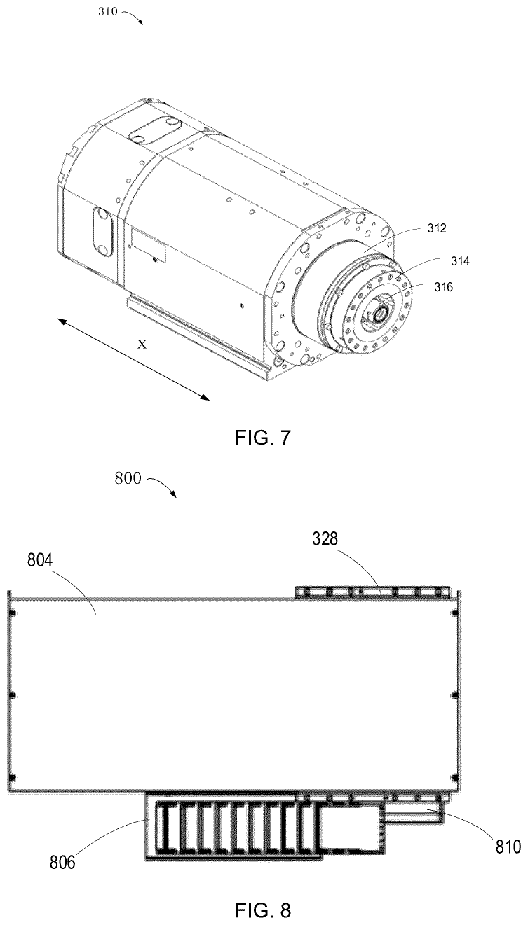

The example construction of the thread machining apparatus 300 will be described with reference to FIGS. 6 and 7. FIG. 6 is a top view of a spindle motor 310 and a feeding device 320 of the thread machining apparatus 300 as shown in FIG. 3 and FIG. 7 is a perspective view of the spindle motor 310 as shown in FIG. 6.

As shown in FIG. 6, the spindle motor 310 is coupled to the feeding device 320. In particular, the spindle motor 310 includes a connecting part 342, which is fixedly connected with a connecting plate 344 of the feeding device 320. The connecting plate 344 of the feeding device 320 can slide along an axis direction X as shown in FIG. 7 with the drive of the driving mechanism in the feeding device 320.

Referring to FIG. 7, a connecting flange 314 is fixed on an output axis 312 of the spindle motor 310, and is adapted to connect a thread tool 200. The spindle motor 310 may further comprise a clamping part 316, which is used to hold the thread tool 200.

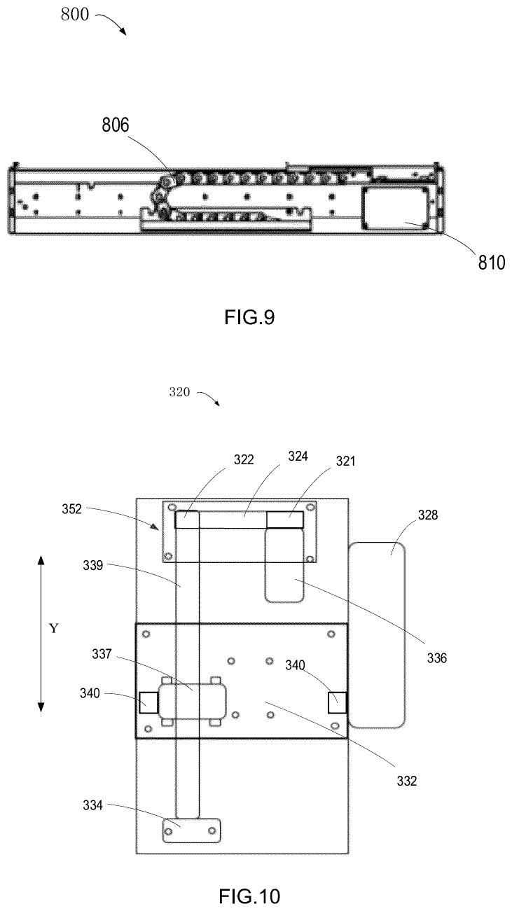

FIG. 8 is a top view of a feeding device 320 in accordance with an embodiment of the present disclosure. FIG. 9 is a front view of a feeding device 320 as shown in FIG. 8. In FIG. 8, an outer frame of a connecting plate of the spindle motor 310 is indicated by 328. A cable train is indicated by 806 in FIGS. 8 and 9, which is used to export cable connecting the feeding device 320 to the servo motor 336 to a control cabinet. Terminal box 810 as shown in FIGS. 8 and 9 is used for the transfer of cable of the feeding device 320, which is convenient for disassembly and maintenance of the feeding device 320.

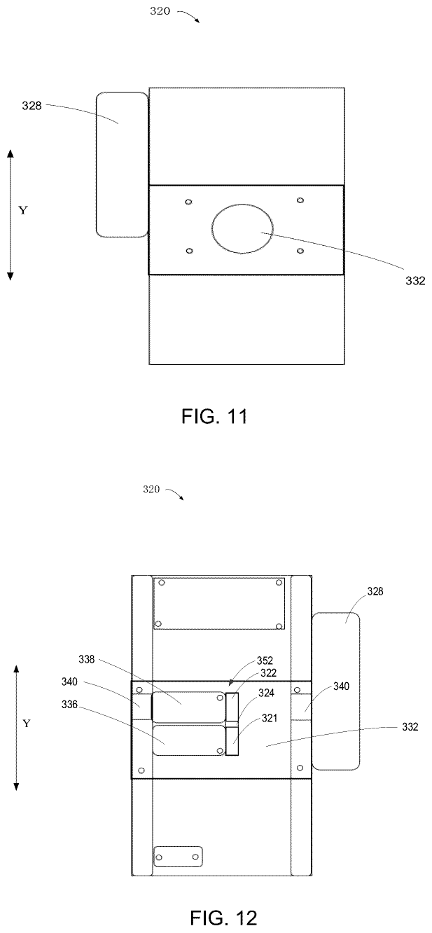

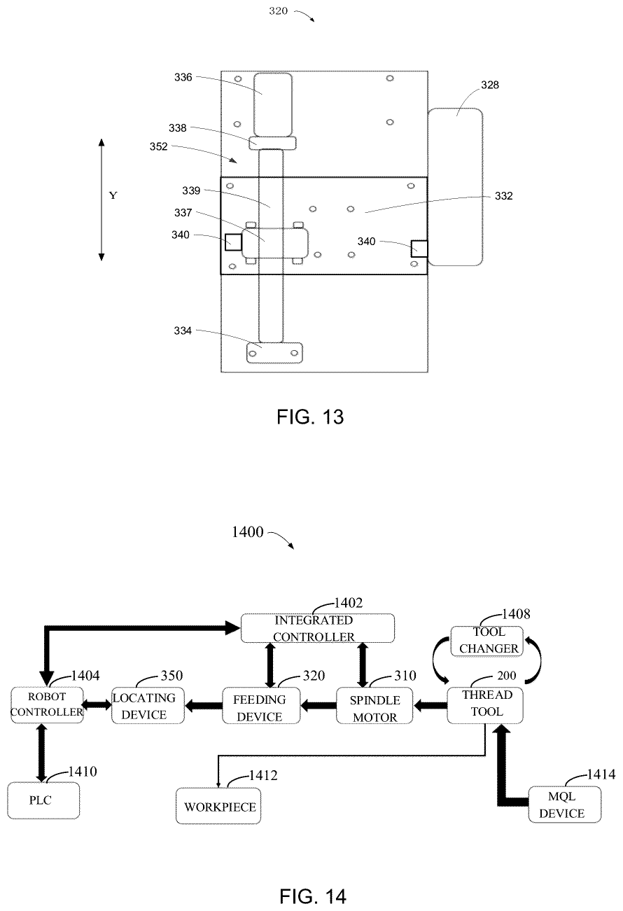

The example configuration of the feeding device 320 will be further described with reference to FIGS. 10-13. FIG. 10 is schematic top view illustrating the configuration of the feeding device 320 in accordance with an embodiment of the present disclosure. FIG. 11 is schematic bottom view of the feeding device 320 as shown in FIG. 10. FIG. 12 is schematic top view illustrating the configuration of the feeding device 320 in accordance with another embodiment of the present disclosure. FIG. 13 is schematic top view illustrating the configuration of the feeding device 320 in accordance with still another embodiment of the present disclosure.

In some embodiments, the feeding device 320 may comprise a servo motor 336 and a transmission device 352. The transmission device 352 is coupled to an output shaft of the servo motor 336 and configured to convert the rotation of the output shaft of the servo motor 336 into a linear movement along the axial direction X of the spindle motor 310 to drive the spindle motor 310. In this way, the spindle motor 310 can achieve an accurate linear movement. The transmission device 352 can be constructed in various manners, and will be further described in conjunction with FIGS. 10-13.

Referring to FIG. 10 first, as shown in FIG. 10, the transmission device 352 generally comprises a first belt pulley 321, a belt 324, second belt pulley 322, a ball screw 339, ball nut 337 and a sliding member 340. The first belt pulley 321 is fixedly coupled to the output shaft of the servo motor 336. The second belt pulley 322 is coupled with the first belt pulley 321 through the belt 324. The ball screw 339 is coupled at one end to the shaft of the second belt pulley 322 and rotates with the second belt pulley 322. The ball screw 339 is coupled at the other end with a support part 334, which is fixedly coupled to the base of the feeding device 320. A ball nut 337 is arranged on the ball screw 339, and configured to move along the axial direction X with the rotation of the ball screw 339. The sliding member 340 is coupled between the ball nut 337 and the spindle motor 310. The sliding member 340 is driven by the ball nut 337 and moves with the ball nut 337 to drive the spindle motor 310 to move along the axial direction X of the spindle motor 310. In this way, the rotation of the output shaft of the servo motor 336 can be converted into a linear movement along the axial direction X of the spindle motor 310 in a simple and reliable way. In some embodiments, the sliding member 340 can be directly connected to the spindle motor 310 and slide along a track in the axial direction X.

FIG. 11 is schematic bottom view of the feeding device 320 as shown in FIG. 10. A plate is indicated by 332, which allows the spindle motor 310 to move thereon with the movement of the sliding member 340.

Referring to FIG. 12, the transmission device 352 generally comprises a first belt pulley 321, a gear box 338, a belt 324, a second belt pulley 322 and a sliding member 340. The first belt pulley 321 is fixedly coupled to the output shaft of the servo motor 336. The second belt pulley 322 is fixedly coupled to a shaft of the gear box 338. The belt 324 couples the first belt pulley 321 with the second belt pulley 322 to drive the second belt pulley 322 along with the first belt pulley 321. The sliding member 340 is coupled between the gear box 338 and the spindle motor 310, and slides with the rotation of the output shaft of the servo motor 336 to drive the spindle motor 310 to move along the axial direction X of the spindle motor 310.

In some embodiments, the gear box 338 may comprise: an external gear (not shown) arranged at a first end of the gear box 338; at least one internal gear (not shown) arranged in the gear box 338 and coupled with the external gear. The internal gear is adapted to drive the external gear. The second belt pulley 322 is located at a second end of the gear box 338 and coupled with a shaft of the internal gear of the gear box 338 and configured to drive the internal gear. The sliding member 340 is coupled between the external gear and the spindle motor 310, the sliding member 340 slides with the rotation of the outer gear to drive the spindle motor 310. In this way, the rotation of the output shaft of the servo motor 336 can be converted into a linear movement along the axial direction of the spindle motor 310 in a simple and reliable way.

In some embodiments, the moving speed of the spindle motor 310 is proportional to product of a circumference of the first belt pulley 321 and a rotational speed of the servo motor 336. In this way, the moving speed of the spindle motor 310 can be accurately controlled in a simple way.

The transmission device 352 will be further described with reference to FIG. 13. As shown in FIG. 13, the transmission device 352 generally comprises a gear box 338, a ball screw 339, a ball nut 337 and a sliding member 340. The gear box 338 is coupled to the output shaft of the servo motor 336. The ball screw 339 is movably coupled to the gear box 338. The ball nut 337 is arranged on the ball screw 339, and configured to move along an axial direction Y of the ball screw 339 with the rotation of the ball screw 339. The sliding member 340 is coupled between the ball nut 337 and the spindle motor 310. The sliding member 340 slides with the movement of the ball nut 337 to drive the spindle motor 310 to move along the axial direction Y of the ball screw 339. In some embodiments, the axial direction Y of the ball screw 339 may be parallel to the axial direction X of the spindle motor 310.

In some embodiments, the transmission device 352 may further comprises a sliding track (not shown) extending along the axial direction X of the spindle motor 310, and the sliding member 340 may slide along the sliding track. In this way, the spindle motor 310 can be driven along the sliding track smoothly.

Though the structures of the transmission device 352 are described above with reference to FIGS. 10-13, it is to be understood that the illustrated structures are only exemplary. The transmission device 352 is not limited to the configuration as described above, but may be of any other configuration. The scope of the present disclosure is not intended to be limited in this respect.

A thread machining apparatus 300 is described. The thread machining apparatus 300 may be implemented in various configurations in accordance with embodiments of the present disclosure. The scope of the present disclosure is not intended to be limited in this respect.

The operation of the thread machining apparatus 300 will be described hereinafter. In some embodiments, the method for thread machining may comprises: driving a thread tool 200 coupled to an output shaft of a spindle motor 310 to rotate at a rotational speed; and driving the spindle motor 310 to move along an axial direction X of the spindle motor 310 at a moving speed; wherein during thread machining, the moving speed is proportional to the rotational speed.

In some embodiments, the spindle motor 310 and the feeding device 320 are controlled synchronously, so that the ratio of the moving speed to the rotational speed is equal to the pitch of the thread tool 200 during tapping and exiting from a threaded hole.

In some embodiments, the spindle motor 310 and the feeding device 320 are controlled synchronously, so that the ratio of the moving speed to the rotational speed is equal to the pitch of the thread tool 200 at least since the thread tool 200 reaches the hole on a workpiece surface where the thread is to be machined.

In some embodiments, the spindle motor 310 and the feeding device 320 are synchronously controlled by a same controller. In this way, the synchronous control of spindle motor and the feeding device can be conveniently and reliably achieved, whereby the machining accuracy can be improved.

The operation of the thread machining apparatus described above is only illustrative. The scope of the present disclosure is not intended to be limited in this respect.

The example construction of a thread machining system 1400 including the thread machining apparatus will be described with reference to FIG. 14. FIG. 14 is a schematic block diagram illustrating the system comprising the thread machining apparatus in accordance with an embodiment of the present disclosure. As shown in FIG. 14, the thread machining system 1400 may include an integrated controller 1402, a robot controller 1404, a locating device 350, a feeding device 320, a spindle motor 310, thread tool 200, a PLC (Programmable Logic Controller) 1410, a workpiece 1412, a MQL device 1414, and a tool changer 1408.

The core concept of synchronization algorithm of the present invention is to establish the mathematical logic relationship between the linear speed of feeding device 320 and the rotational speed of spindle motor 310, so as to realize the accurate motor synchronization between them.

The inventor of the present invention realized that in order to obtain high machining accuracy, it is very critical that the moving speed (feeding speed) is proportional to the rotational speed.

Specifically, during tapping, the feed along the pitch direction, i.e. the axis direction of the spindle motor 310, shall preferably maintain a strict speed ratio relationship with the rotation of the spindle motor 310. For each rotation of the spindle motor 310, the total feed of the feeding device 320 shall be equal to the pitch of the tap, so as to achieve the synchronization of feed and tapping, that is:

F=P*S1 (1)
wherein P represents the pitch of tap (mm/R), (for example, as shown in FIG. 2), F represents the feeding speed of feeding device 320 (mm/min) and S1 represents the rotational speed of the spindle motor 310 (R/min)

The relationship of the feeding speed of feeding device 320 and the rotational speed of the spindle motor 310 described above is only illustrative. The scope of the present disclosure is not intended to be limited in this respect.

It can be derived from the formula (1) that the ratio of the moving speed to the rotational speed is equal to the pitch (P, as shown in FIG. 2) of the thread tool 200. As a result, the machining accuracy of thread machining can be significantly improved. For example, thread sliding (screw loose), damage to surface roughness, tool material plasticity damage and so on can be avoided.

It is to be understood that the thread machining apparatus 300 and method of the present invention are not intended to be limited in this respect. The ratio of the moving speed to the rotational speed can vary within a predetermined range depending on actual requirement, for example, 0.9 times the pitch of the thread tool 200 to 1.1 times pitch of the thread tool 200, or 0.95 times the pitch of the thread tool 200 to 1.05 times the pitch of the thread tool 200. It is also possible to obtain satisfactory thread machining accuracy.

In some embodiments, the feeding device 320 is a motor-pulley structure, and the relationship between the feeding speed F and the feeding device 320 may be as follows:

S2=F/C (2)
wherein C represents the pulley circumference (mm/R) and S2 represents the rotational speed of feeding device 320 (R/min)

This formula (2) does not take transmission ratio of other transmission mechanism in the feeding device 320 into account. If the transmission ratio is taken into account, this formula needs to be multiplied by a corresponding coefficient. In brief, in some embodiments, the moving speed is proportional to product of a circumference of the first belt pulley 321 and a rotational speed of the servo motor 336.

In order to adapt to the machining of different types of threaded holes, the tool changer 1408 may cooperate with the tool/tool holder 1406, and change the tool automatically.

The heads of thread tool 200 may be equipped with peripheral micro lubricating fluid (MQL) device 1414, which performs atomization spraying during thread machining, so as to improve the feeding speed, inhibit temperature rise, reduce tool wear, and increase the service life of the thread tool 200.

The PLC 1410 may communicate with the robot controller 1404, and may execute and control the task list, and strictly defines safety protection measures.

The integrated controller 1402 has compact layout and design. It integrates the drive of the feeding device 320 and the spindle motor 310 for one-driving-two synchronous control. It has good synchronization, and system delay can be avoided.

Based on the design of the integrated controller and the unique advantages of physical structure and encoder software programming, the motor synchronization algorithm in the process of feeding and withdrawal in thread machining is realized.

In the above embodiments, the machining of internal threads is described as an example. Actually, the thread machining apparatus 300 and method of the present invention are not intended to be limited in this respect. The thread machining apparatus and method of the present invention can be applied to external thread machining as long as the spindle motor is equipped with a thread tool 200 for machining external threads.

It is to be understood that the apparatus is not limited to the configuration as described above, but may be of any other configuration. The scope of the present disclosure is not intended to be limited in this respect.

Moreover, the apparatus can be combined with one or more additional apparatus to operate as needed. The scope of the present disclosure is not intended to be limited in this respect.

The optimization solution provided by the embodiment of the present invention solves the problems of high cost, low efficiency, poor stability and out-sync mentioned above. The 6-axis industrial robot may be added with a feeding device, for example, a single axis servo flexible positioning device, and the spindle motor and thread tool 200 are mechanically connected. Moreover, in order to better realize the synchronization between the linear movement of the spindle motor and the rotational movement of the spindle motor, the physical connection and synchronization algorithm between the feeding device and the spindle motor are designed to solve the problem that the motor speed is not synchronized due to separate control which causes the problem that two devices cannot be controlled and related by the same process algorithm, so as to avoid the phenomenon of thread sliding and stuck cutter.

The innovative optimization solution provided by embodiments of the present invention makes use of the advantages of the flexibility, economy of the industrial robot. In particular, a single axis servo flexible positioning device (feeding device) is added as an intermediary motion mechanism, mechanical impact on the robot is reduced. Thus, the problem of insufficient rigidity of the robot is solved.

Moreover, embodiments of the present disclosure allow the integrated design of the single axis servo flexible positioning device and a driving unit of the spindle motor. It is more flexible in synchronous control and can effectively reduce the synchronous speed delay of the spindle motor under the same system. The solution of the present invention has significantly improved the cost, efficiency, stability and accuracy of thread machining.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A thread machining apparatus, comprising:
a spindle motor adapted to drive a thread tool coupled to an output shaft of the spindle motor to rotate at a rotational speed; and
a feeding device movably coupled to the spindle motor and configured to drive the spindle motor to move along an axial direction (X) of the spindle motor at a moving speed;
wherein during thread machining, the moving speed is proportional to the rotational speed.

2. The thread machining apparatus according to claim 1, wherein a ratio of the moving speed to the rotational speed is equal to a pitch of the thread tool.

3. The thread machining apparatus according to claim 1, wherein the feeding device comprises:
a servo motor; and
a transmission device coupled to an output shaft of the servo motor and configured to convert the rotation of the output shaft of the servo motor into a linear movement along the axial direction (X) of the spindle motor to drive the spindle motor.

4. The thread machining apparatus according to claim 3, wherein the transmission device comprises:
a gear box coupled to the output shaft of the servo motor;
a ball screw movably coupled to the gear box;
a ball nut arranged on the ball screw, and configured to move along an axial direction (Y) of the ball screw with the rotation of the ball screw; and
a sliding member coupled between the ball nut and the spindle motor, the sliding member sliding with the movement of the ball nut to drive the spindle motor to move along the axial direction (Y) of the ball screw.

5. The thread machining apparatus according to claim 3, wherein the transmission device comprises:
a first belt pulley fixedly coupled to the output shaft of the servo motor;
a gear box;
a second belt pulley fixedly coupled to a shaft of the gear box;
a belt coupled the first belt pulley with the second belt pulley
to drive the second belt pulley along with the first belt pulley; and
a sliding member coupled between the gear box and the spindle motor, the sliding member sliding with the rotation of the output shaft of the servo motor to drive the spindle motor to move along the axial direction (Y) of the spindle motor.

6. The thread machining apparatus according to claim 3, wherein the transmission device comprises:
a first belt pulley fixedly coupled to the output shaft of the servo motor;
a belt;
a second belt pulley coupled to the first belt pulley via the belt;
a ball screw coupled to a shaft of the second belt pulley and rotates with the rotation of the second belt pulley;
a ball nut arranged on the ball screw, and configured to move along the axial direction (Y) of the ball screw with the rotation of the ball screw, and
a sliding member coupled between the ball nut and the spindle motor, the sliding member sliding with the movement of the ball nut to drive the spindle motor to move along the axial direction (X) of the spindle motor.

7. The thread machining apparatus according to claim 5, wherein the moving speed is proportional to product of a circumference of the first belt pulley and a rotational speed of the servo motor.

8. The thread machining apparatus according to claim 4, wherein the transmission device further comprises:
a sliding track extending along the axial direction (X) of the spindle motor, the sliding member sliding along the sliding track.

9. The thread machining apparatus according to claim 1, further comprising:
a positioning mechanism fixedly coupled to the feeding device and adapted to position the feeding device to align the thread tool with a hole of a thread to be machined of the workpiece.

10. The thread machining apparatus according to claim 9,
wherein the positioning mechanism comprises a robot, and
wherein the feeding device is fixedly coupled to an end of a mechanical arm of the robot.

11. The thread machining apparatus according to claim 1, wherein the spindle motor comprises:
a clamping part adapted to hold the thread tool;
a controller adapted to control the rotational speed of the spindle motor; and
an encoder coupled to the controller and configured to
transmit the rotation number of the spindle motor to the controller of the spindle motor in a speed control mode, so that the controller controls the rotational speed of the spindle motor; and
transmit the position of the clamping part of the spindle motor holding the thread tool in a position control mode, so as to control the output shaft of the spindle motor to rotate to a predetermined position to replace the thread tool.

12. The thread machining apparatus according to claim 1, wherein the thread tool comprises a tap.

13. A thread machining method, comprising:
driving a thread tool coupled to an output shaft of a spindle motor to rotate at a rotational speed; and
driving the spindle motor to move along an axial direction (X) of the spindle motor at a moving speed;
wherein during thread machining, the moving speed is proportional to the rotational speed.

14. The thread machining method according to claim 13, wherein: a ratio of the moving speed to the rotational speed is equal to a pitch of the thread tool.

15. The thread machining method according to claim 13, wherein: the spindle motor and the feeding device are controlled synchronously, so that the ratio of the moving speed to the rotational speed is equal to the pitch of the thread tool during tapping and exiting from a threaded hole.

16. The thread machining method according to claim 13, wherein: the spindle motor and the feeding device are controlled synchronously, so that the ratio of the moving speed to the rotational speed is equal to the pitch of the thread tool at least since the thread tool reaches the hole on a workpiece surface where the thread is to be machined.

17. The thread machining method according to claim 13, wherein the spindle motor and the feeding device are synchronously controlled by a same controller.

18. A thread machining system comprising a thread machining apparatus according to claim 1.
